(19) United States
(12) Patent Application Publication
(10) Pub. No.: US 2012/0044794 A1
(43) Pub. Date: Feb. 23, 2012

(54) DISCRIMINATION METHOD OF OPTICAL DISC

(76) Inventors: An-Te Liu, Taoyuan County (TW); Shih-Jung Huang, Taoyuan County (TW)

(21) Appl. No.: 13/189,583

(22) Filed: Jul. 25, 2011

(30) Foreign Application Priority Data
Aug. 19, 2010 (TW) 099127905

(51) Int. Cl. G11B 7/00

(52) U.S. Cl. 369/53.22; G9B/7

(57) ABSTRACT

A discrimination method of an optical disc. The method includes: focusing a light spot on a rewritable zone of the optical disc; reading an EFM signal of data marks of the optical disc to check if the optical disc is a data disc or a blank disc; when the optical disc is a data disc, utilizing an SBAD signal for discrimination of the optical disc; when the optical disc is a blank disc, utilizing a DPD signal for discrimination of the optical disc; checking if the header signals exist or not; identifying the optical disc as a DVD-RAM disc if the header signals exist; and identifying the optical disc as a DVD-RW disc if there is no header signal. In this way, the accuracy of the optical disc discrimination is enhanced.

### BACKGROUND OF THE INVENTION

1. Field of the Invention

The present invention relates to a discrimination method of an optical disc, and more particularly, to a method for identifying whether an optical disc is a Digital Versatile Disc-Random Access Memory (DVD-RAM) disc or a Digital Versatile Disc-ReWritable (DVD-RW) disc when the optical disc is accessed (i.e., read or written) by an optical disc drive.

2. Description of the Prior Art

Optical discs can be divided into different specifications, such as Compact Disc (CD), Video Compact Disc (VCD), Digital Versatile Disc (DVD), and Blu-ray Disc (BD), according to their storage capacities. Besides, the optical discs can be categorized into Read Only Memory (ROM) discs, Write-once (R) discs, ReWritable (RW) discs, and Random Access Memory (RAM) discs according to the reading/writing requirements. However, the optical characteristics of the optical discs vary with their storage capacities and disc types. Thus, the optical disc drive has to identify the type of the optical disc for properly adjusting the servo parameters to ensure valid reading/writing operations applied to the optical disc.

Among all the optical discs, the rewritable optical discs, such as DVD-RAM discs, are more complex than other types of optical discs. Please refer to FIG. 1, which is a diagram illustrating a data structure of a DVD-RAM disc. As shown in FIG. 1, the surface of a DVD-RAM disc 10 is divided into an embossed zone 11 and a rewritable zone 12. The embossed zone 11 is located at the inner-most part of the DVD-RAM disc 10, and used for providing the disc information, such as a storage capacity and type if the DVD-RAM disc 10. The embossed zone 11 is surrounded by the rewritable zone 12. The rewritable zone 12 is utilized for recording the user data. The major difference between the DVD-RAM disc 10 and other optical discs is that the rewritable zone 12 is divided into a plurality of sectors by a header 13, thereby allowing recording of the user data in sectors. The header 13 with a higher reflection rate is utilized for storing physical addresses respectively corresponding to data stored in the sectors, thereby allowing the DVD-RAM disc 10 to randomly delete data and/or write data as a hard disk does. In this manner, the optical disc drive can identify the type of the optical disc by detecting the high reflection signal of the header 13 to check if the optical disc is a DVD-RAM disc 10.

However, regarding a blank DVD-RAM disc, the reflection rate of its user data area is close to the reflection rate of its header. As a result, it is difficult to identify the reflection signal of the header of a blank DVD-RAM disc. Hence, a blank DVD-RAM disc would probably be erroneously identified as a DVD-RW disc, which leads to incorrect read/write operations of the optical disc. It is therefore, a demand for solving the problem of discriminating between a DVD-RAM disc and a DVD-RW disc that is encountered by the prior art.

### SUMMARY OF THE INVENTION

It is therefore one of the objectives of the present invention to provide a discrimination method of an optical disc. The present invention first determines whether the optical disc is a data disc or a blank disc, and then selects a sub-beam added (SBAD) signal or a differential phase detection (DPD) signal according the characteristics of the optical disc for identifying the type of the optical disc correctly.

To achieve the aforementioned objective, the disclosed discrimination method of an optical disc includes following steps: focusing on a rewritable zone of the optical disc; checking whether the optical disc is a data disc or a blank disc by checking the existence of an Eight-to-Fourteen Modulation (EFM) signal (the data mark signal of the optical disc); utilizing the SBAD signal to identify the type of the optical disc when the optical disc is a data disc; and utilizing the DPD signal to identify the type of the optical disc when the optical disc is a blank disc; checking the existence of the header signals; identifying the optical disc as a DVD-RAM disc when the header signals exist; and identifying the optical disc as a DVD-RW disc when there is no header signal, wherein the step of utilizing the SBAD signal to identify the type of the optical disc comprises checking an SBAD signal of the header in the rewritable zone and an SBAD signal of the user data area in the rewritable zone; and the step of utilizing the DPD signal to identify the type of the optical disc comprises executing a track-on operation first, and then checking a DPD signal of the header in the rewritable zone and a DPD signal of the user data area in the rewritable area. When checking if the header signals exist or not, a predetermined threshold is set, and the length of a checking period is longer than the length of accessing one or more sectors. The existence of the header signals is checked by counting the number of header signals exceeding the predetermined threshold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data structure of a conventional DVD-RAM disc.

FIG. 2 is a diagram illustrating an optical disc drive generating an SBAD signal according to an exemplary embodiment of the present invention.

FIG. 3 is a diagram illustrating an SBAD signal generated by an optical disc drive that accesses a DVD-RAM data disc according to an exemplary embodiment of the present invention.

FIG. 4 is a diagram illustrating an SBAD signal generated by an optical disc drive that accesses the DVD-RAM blank disc according to an exemplary embodiment of the present invention.

FIG. 5(a) is a diagram illustrating the optical disc drive that generates a DPD signal according to an exemplary embodiment of the present invention.

FIG. 5(b) is a diagram illustrating the formation of the DPD signal according to an exemplary embodiment of the present invention.

FIG. 6 is a diagram illustrating a partial structure of the data track of a DVD-RAM data disc according to an exemplary embodiment of the present invention.

FIG. 7 is a diagram illustrating a DPD signal that is generated when a DVD-RAM data disc is being accessed according to an exemplary embodiment of the present invention

FIG. 8 is a diagram illustrating the DPD signal that is generated when there is an offset during the track-on operation.

FIG. 9 is a diagram illustrating a partial structure of the data track of a DVD-RAM blank disc according to an exemplary embodiment of the present invention.

FIG. 10 is a flowchart illustrating a discrimination method of an optical disc according to an exemplary embodiment of the present invention.

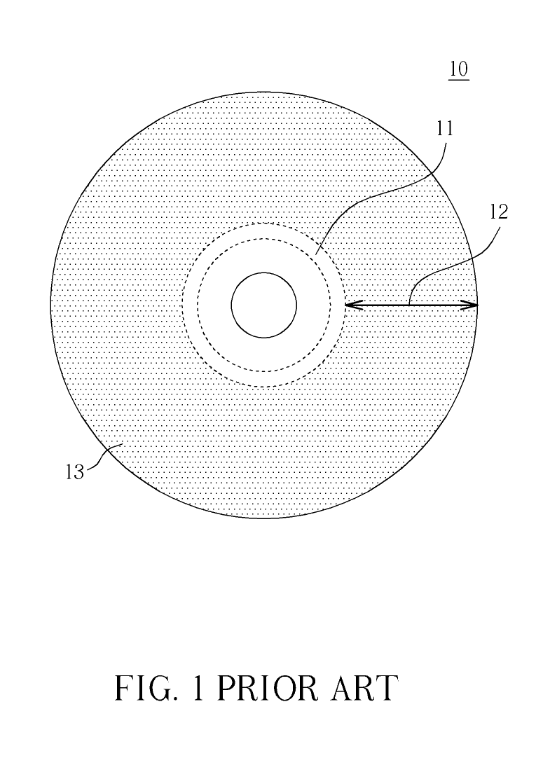

### DETAILED DESCRIPTION

The technical features of the present invention will be described in detail hereinafter by way of preferred embodiments with reference to the drawings.

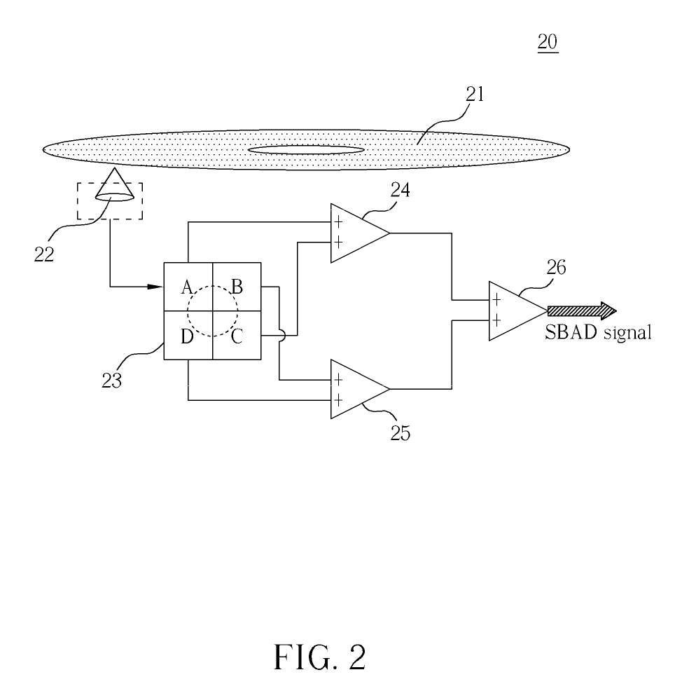

Please refer to FIG. 2, which is a diagram illustrating an optical disc drive generating a sub-beam added signal according to an exemplary embodiment of the present invention. The optical disc drive 20 is an apparatus utilized for accessing an optical disc 21, and includes an optical pickup head 22, a photo detector 23, a first adder 24, a second adder 25, and a third adder 26. When the optical disc drive 20 is accessing the optical disc 21, the optical pickup head 22 emits a laser beam upon the optical disc 21 and then receives a reflected beam from the optical disc 21, where the reflected beam is projected to the photo detector 23. The photo detector 23 has four sensing areas A, B, C, and D used for generating signals A, B, C, and D by converting the respective received luminous flux into electrical signals, respectively. Next, a signal (A+C) is generated from summing up two of the four signals A-D through the first adder 24, and a signal (B+D) is generated from summing up the other two of the four signals A-D through the second adder 25. When the signal (A+C) and the signal (B+D) are added together through the third adder 26, a sub-beam added (SBAD) signal is generated accordingly.

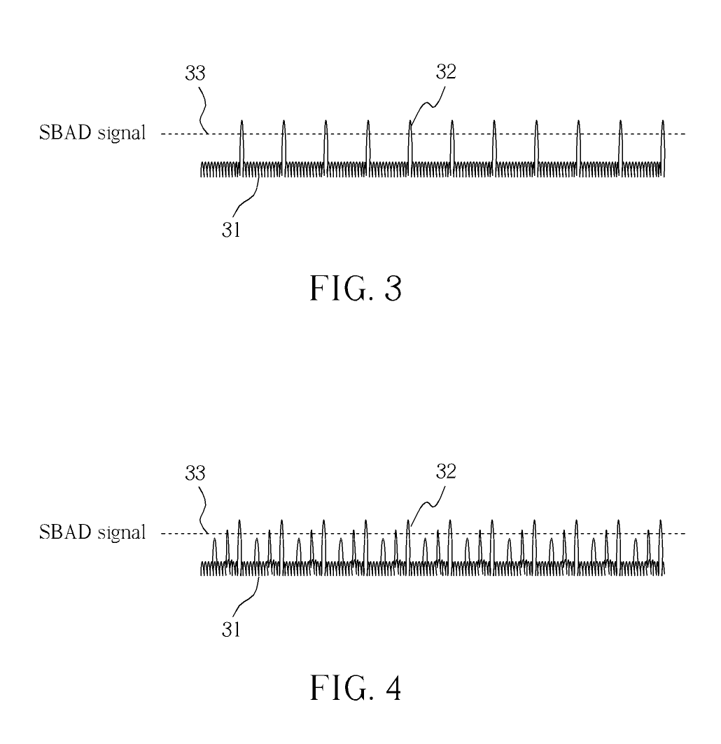

Please refer to FIG. 3 and FIG. 4. FIG. 3 is a diagram illustrating an SBAD signal generated by an optical disc drive that accesses a DVD-RAM data disc according to an exemplary embodiment of the present invention. FIG. 4 is a diagram illustrating an SBAD signal generated by an optical disc drive that accesses a DVD-RAM blank disc according to an exemplary embodiment of the present invention. As shown in FIG. 3, when the optical disc drive accesses an optical disc, the optical pickup head needs to emit a laser beam focused on the optical disc. If the optical disc is a DVD-RAM data disc with the rewritable zone having user data recorded therein, the reflection rate of the optical disc is decreased. At this time, the reflection rate of the header is obviously higher than the reflection rate of the user data area. Thus, the detected SBAD signal includes user data area signals 31 with lower peak values and header signals 32 with higher peak values exceeding a predetermined threshold 33 of the SBAD signal. In this way, by utilizing the obvious difference between the user data area signals 31 and the header signals 32, the header signals can be found easily for identifying the optical disc as a DVD-RAM data disc.

However, as shown in FIG. 4, if the optical disc is a DVD-RAM blank disc with a data area that is not used for recording user data yet, the blank rewritable zone also has a higher reflection rate. At this time, the reflection rate of the header is close to the reflection rate of the user data area. That is, the user data area signals 31 included in the SBAD signal derived from a blank optical disc are similar to the header signals 32 included in the SBAD signal derived from the blank optical disc. As a result, as the optical disc drive has difficulty in correctly identifying the header signals by using the predetermined threshold 33 of the SBAD signal, it is difficult to precisely identify the optical disc as a DVD-RAM blank disc by referring to the SBAD signal. That is, the SBAD signal is more suitable for discrimination of a DVD-RAM data disc.

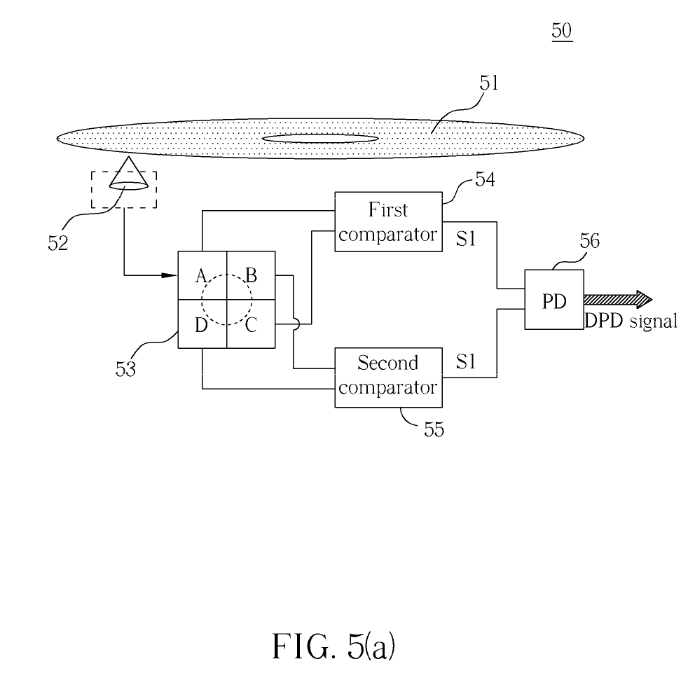

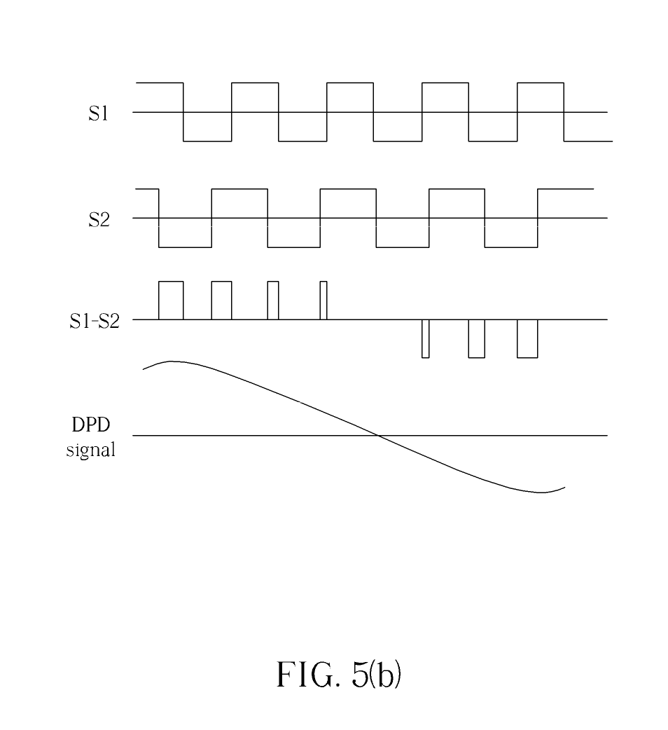

Please refer to FIG. 5(a) in conjunction with FIG. 5(b). FIG. 5(a) is a diagram illustrating the optical disc drive that generates a differential phase detection (DPD) signal according to an exemplary embodiment of the present invention. FIG. 5(b) is a diagram illustrating the formation of the DPD signal according to an exemplary embodiment of the present invention. Similarly, the optical disc drive 50 utilizes four sensing areas A, B, C, and D of a photo detector 53 for obtaining four signals. The signal A and the signal C generated from sensing areas located at diagonal locations are compared by a first comparator 54, and the signal B and the signal D generated from sensing areas located at other diagonal locations are compared by the second comparator 55. Accordingly, phase signals S1 and S2 are generated from the first comparator 54 and the second comparator 55, respectively. When the phase of the phase signal S2 is subtracted from the phase of the phase signal S1 through a phase detector (PD) 56, a phase difference signal (S1-S2) is thereby generated. The phase difference signal (S1-S2) is a differential phase detection (DPD) signal.

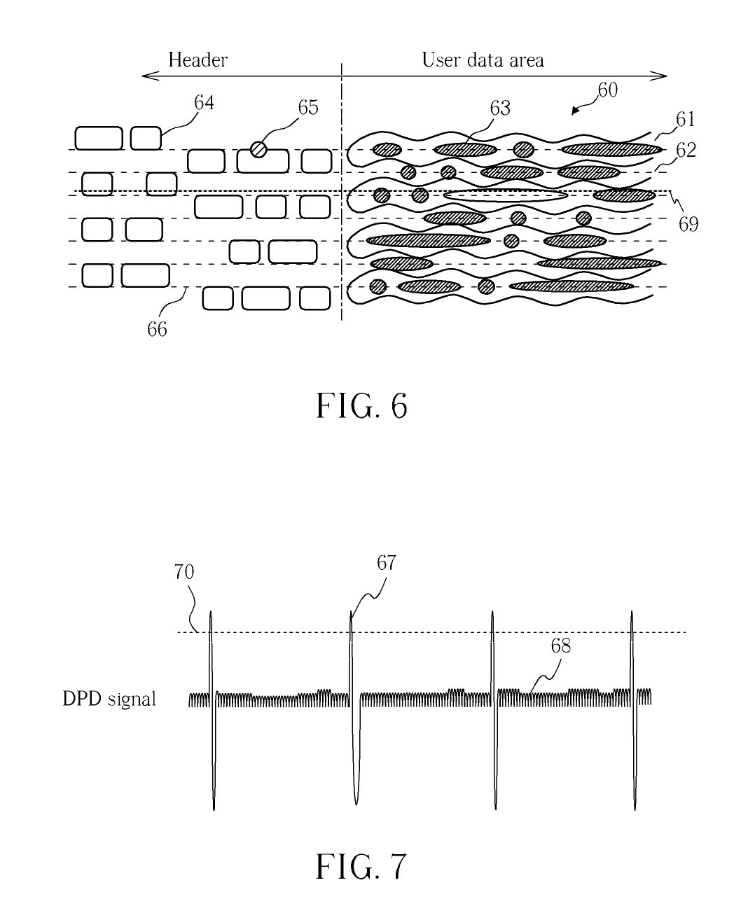

Please refer to FIG. 6 in conjunction with FIG. 7. FIG. 6 is a diagram illustrating a partial structure of the data track of a DVD-RAM data disc according to an exemplary embodiment of the present invention. FIG. 7 is a diagram illustrating a DPD signal that is generated when a DVD-RAM data disc is being accessed according to an exemplary embodiment of the present invention. As shown in FIG. 6, the data track 60 of the DVD-RAM disc is constructed by grooves 61 and lands 62, and each of the recording sectors has a user data area immediately follows the header. When data is recorded onto the DVD-RAM disc, marks 63 will be formed at grooves 61 and lands 62. Besides, there are a plurality of pre-embossed pits 64 for providing the physical address information of to the recording sectors.

When the DVD-RAM data disc is being accessed, a light spot 65 projected by the optical pickup head is locked to the data track 60 correctly, and moves along a midline 66 of the data track 60 to access the DVD-RAM disc. Since the pits 64 of the header are merely located at one side of the midline 66 of the data track 60 (e.g., located at the upper side of the midline 66), the sensing areas (B+D) detect the pits 64 of the header earlier than the sensing areas (A+C), and the phase signal S2 is a phase leading signal, thereby making the phase signal S2 have larger amplitude and the phase signal 51 have amplitude equal to zero. As a result, the DPD signal is a phase difference signal with an upper part reaching the heist level. On the other hand, if the pits 64 are located at the lower side of the midline 66, the sensing areas (A+C) detect the pits of the header earlier than the sensing areas (B+D), and the phase signal 51 is a phase leading signal. At this time, the phase signal 51 has larger amplitude and the phase signal S2 has amplitude equal to zero. As a result, the DPD signal is a phase difference signal with a lower part reaching a lowest level. By the above operations, the header signals 67 having larger amplitude in the DPD signal shown in FIG. 7 are generated. When the light spot 65 keeps moving along the midline 66 of the data track 60 and enters the groove 61 or land 62 of the user data area for accessing the DVD-RAM data disc, the light spot 65 exactly moves along the midline 66 of the mark 63 with two symmetrical sides. Hence, the phase signal 51 corresponding to the sensing areas (A+C) is almost the same as the phase signal S2 corresponding to the sensing areas (B+D), resulting in a phase difference close to zero. As a result, user data area signals 68 with smaller amplitude in the DPD signal are generated. That is, by utilizing the predetermined threshold 70 of the DPD signal, the existence of the header signals can be easily checked.

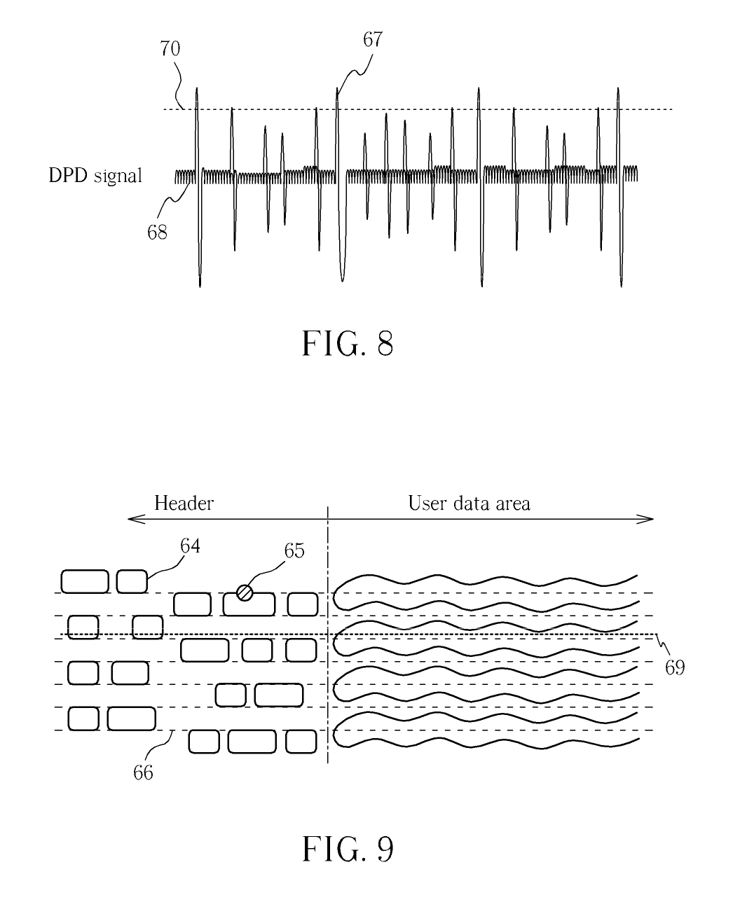

Please refer to FIG. 8 in conjunction with FIG. 6. FIG. 8 is a diagram illustrating the DPD signal that is generated when there is an offset during the track-on operation. As shown in FIG. 6, when the optical disc is eccentric or when the servo system of the optical disc drive is abnormal, the optical pickup head fail to move along the normal midline 66 of the track and is locked to an offset on-track path 69. Hence, the pits 64 of the header are allocated at two sides of the offset on-track path 69, resulting in a reduced phase difference between the phase signal S1 corresponding to the sensing areas (A+C) and the phase signal S2 corresponding to the sensing areas (B+D). Thus, as shown in FIG. 7, the header signals 67 with reduced amplitude in the DPD signal are generated. However, due to the fact that the offset on-track path 69 is shifted to one side of the data track 60, when the mark 63 of the user data area is accessed, the phase difference between the phase signal S1 corresponding to the sensing areas (A+C) and the phase signal S2 corresponding to the sensing areas (B+D) is increased and similar to that generated from accessing the header. As a result, user data area signals with increased amplitude in the DPD signal are generated. Therefore, it is difficult to identify header signals by utilizing the predetermined threshold 70 of the DPD signal. That is, in a case where a normal DVD-RAM data disc and a normal optical disc drive are present, the header signals 67 and the user data area signals 68 can be easily discriminated by referring to the DPD signal generated from subtracting the phase signal S2 corresponding to the sensing areas (B+D) from the phase signal S1 corresponding to the sensing areas (A+C). However, in another case where an abnormal DVD-RAM data disc and/or an abnormal optical disc drive are present, the DPD signal generated by subtracting the phase signal S2 from the phase signal S2 is easily to be affected by the abnormal DVD-RAM disc and/or the abnormal optical disc drive. As the header signals 67 and the user data area signals 68 of the DPD signal are quite similar to each other, the probability of erroneously identifying the type of the optical disc is high.

Please refer to FIG. 9, which is a diagram illustrating a partial structure of the data track of a DVD-RAM blank disc according to an exemplary embodiment of the present invention. For a DVD-RAM blank disc, no matter whether the optical disc and/or the optical disc drive are normal or not, the pits 64 located one side of the data track still make the DPD signal generated from subtracting the phase signal S2 corresponding to the sensing areas (B+D) from the phase signal S1 corresponding to the sensing areas (A+C) maintain at larger amplitude, regardless of the optical pickup head moving along the midlines 66 or the offset on-track path 69. When the optical pickup head moves to the user data area, the reflection rates of two sides of the offset on-track path 69 are identical to each other since there are no marks. That is, the phase difference between the phase signal S1 corresponding to the sensing areas (A+C) and the phase signal S2 corresponding to the sensing areas (B+D) is almost zero, which makes the user data area signals of the DPD signal have amplitude almost equal to zero. The waveform of the DPD signal generated from accessing a DVD-RAM blank disc is similar to that of the DPD signal shown in FIG. 7, and the difference therebetween is that the DPD signal now has smaller amplitude. However, though the DPD signal has smaller amplitude, the header signals and the user data area signals can be easily discriminated by referring to the DPD signal. By utilizing the predetermined threshold 70 of the DPD signal, the existence of header signals can be efficiently checked. Therefore, the DPD signal is more appropriate for discrimination of the DVD-RAM blank disc.

The discrimination method of the type of the optical disc according to the present invention utilizes the aforementioned SBAD signal which can be used to identify the DVD-RAM data disc correctly and the aforementioned DPD signal which can be used to identify the DVD-RAM blank disc correctly. Before the optical disc discrimination is performed, the optical disc drive accesses the optical disc to check existence of data mark signals for determining whether the optical disc is a data disc or a blank disc. The existence of a signal of data marks of the optical disc may be checked by checking an Eight-to-Fourteen Modulation (EFM) signal. If the EFM signal exists, meaning that there are recorded marks on the optical disc, the optical disc at this time is a data disc with data recorded thereon. If the EFM signal does not exist, meaning that there are no recorded marks on the optical disc, the optical disc at this time is a blank disc. After the operation of checking if the optical disc is a data disc or a blank disc is completed, an SBAD-based discrimination method which utilizes a predetermined threshold of an SBAD signal to check existence of the header signals is employed if the optical disc is a data disc, and a DPD-based discrimination method which utilizes a predetermined threshold of a DPD signal to check existence of header signals is employed if the optical disc is a blank disc. If the optical disc has header signals, it is identified as a DVD-RAM disc; otherwise, it is identified as a DVD-RW disc. In the end, the type of the optical disc can be identified correctly.

Because the rewritable zone is divided into sectors by the header and each sector has a fixed length, the operation of checking the header signals is allowed to check at least one sector instead of checking all of the sectors, thereby shortening the processing time of identifying the type of the optical disc. That is, the length of a checking period of checking the existence of header signals is required to be not shorter than the length of accessing one sector. However, for enhancing the accuracy of the discrimination of the optical disc type, the length of the checking period of checking the existence of header signals is preferably to encompass the length of accessing a plurality of sectors. Besides, only when the number of the header signals exceeding the predetermined threshold is greater than a predetermined value, the existence of header signals is confirmed.

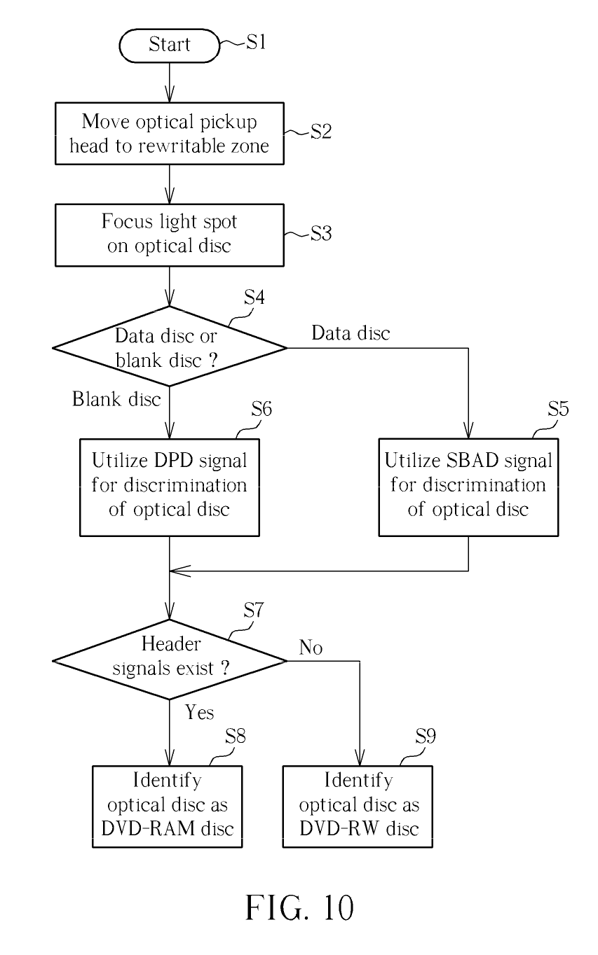

FIG. 10 is a flowchart illustrating the discrimination method of the optical disc according to an exemplary embodiment of the present invention. The detailed steps of the discrimination method of the present invention which utilizes the SBAD signal or the DPD signal is described in the following. Step S1 is executed to start the discrimination process of the optical disc. Next, in Step S2, the optical pickup head is moved to the rewritable zone of the optical disc. In Step S3, the optical pickup head focuses a light spot on the optical disc. In Step S4, it is checked to see if the optical disc is a data disc or a blank disc by checking the existence of a data mark signal of the optical disc. If the optical disc is a data disc, the flow proceeds with Step S5. If the optical disc is a blank disc, the flow proceeds with Step S6. In Step S5, the SBAD signal is utilized for discrimination of the optical disc; next, the flow proceeds with Step S7. In Step S6, the track-on operation is first executed, and then the DPD signal is utilized for discrimination of the optical disc. In Step S7, the SBAD/DPD signal is checked to see if the header signals exist or not. If the header signals exist, the flow proceeds with Step S8 to identify the optical disc as a DVD-RAM disc. If there is no header signal in the SBAD/DPD signal, the flow proceeds with Step S9 to identify the optical disc as a DVD-RW disc.

In conclusion, the discrimination method of the optical disc provided in this invention firstly checks if the optical disc is a data disc or a blank disc. When the optical disc is a blank disc, the track-on operation is executed, and the existence of header signals is checked by using the DPD signal. When the optical is a data disc, the SBAD signal is utilized to check if the header signals exist. Therefore, the discrimination of the optical disc is accomplished based on the checking result of the existence of header signals. In this way, the objective of identifying the DVD-RAM disc correctly is achieved.

Those skilled in the art will readily observe that numerous modifications and alterations of the device and method may be made while retaining the teachings of the invention.

What is claimed is:

1. A discrimination method of an optical disc, comprising:
(1) focusing a light spot on a rewritable zone of the optical disc;
(2) checking if the optical disc is a data disc or a blank disc, where Step (3) is executed if the optical disc is the data disc, and Step (4) is executed if the optical disc is the blank disc;
(3) identifying the optical disc by utilizing a sub-beam added (SBAD) signal, and proceeding with Step (5);
(4) identifying the optical disc by utilizing a differential phase detection (DPD) signal; and
(5) checking if header signals exist, wherein the optical disc is identified as a DVD-RAM disc if the header signals exist; and the optical disc is identified as a DVD-RW disc if there is no header signal.

2. The discrimination method of claim 1, wherein Step (2) checks if the optical disc is the data disc or the blank disc by checking existence of a data mark signal of the optical disc; the optical disc is identified as the data disc if the data mark signal exists; and the optical disc is identified as the blank disc if the data mark signal does not exist.

3. The discrimination method of claim 2, wherein the data mark signal of the optical disc is an eight-to-fourteen modulation (EFM) signal.

4. The discrimination method of claim 1, wherein Step (3) comprises: detecting an SBAD signal of a header and an SBAD signal of a user data area in the rewritable zone of the optical disc.

5. The discrimination method of claim 1, wherein Step (4) comprises: detecting a DPD signal of a header and a DPD signal of a user data area in the rewritable zone of the optical disc.

6. The discrimination method of claim 1, wherein Step (4) further comprises: performing a track-on operation before identifying the optical disc by utilizing the DPD signal.

7. The discrimination method of claim 1, wherein Step (5) comprises:
setting a predetermined threshold; and
checking if a header signal exists by checking if the header signal exceeds the predetermined threshold.

8. The discrimination method of claim 7, wherein the step of setting the predetermined threshold comprises:
when the SBAD signal is utilized for discrimination of the optical disc, setting the predetermined threshold corresponding to the SBAD signal; and
when the DPD signal is utilized for discrimination of the optical disc, setting the predetermined threshold corresponding to the DPD signal.

9. The discrimination method of claim 7, wherein Step (5) further comprises: utilizing a header to divide the rewritable zone into a plurality of sectors, wherein a length of a checking period for checking if the header signals exist is longer than a length of accessing one sector.

10. The discrimination method of claim 9, wherein the step of checking if the header signals exist comprises:
counting a number of header signals exceeding the predetermined threshold; and
determining that the header signals exist when the number of header signals exceeding the predetermined threshold is greater than a predetermined value.
